(19) United States
(12) Patent Application Publication
(10) Pub. No.: US 2011/0237374 A1
(43) Pub. Date: Sep. 29, 2011

(54) TOOTHED BELT

(75) Inventors: Hideyuki NAKAO, Osaka (JP); Masato TOMOBUCHI, Osaka (JP); Masaru KANAMORI, Osaka (JP)

(73) Assignee: TSUBAKIMOTO CHAIN CO., Osaka (JP)

(21) Appl. No.: 13/050,336

(22) Filed: Mar. 17, 2011

(30) Foreign Application Priority Data
Mar. 23, 2010 (JP) 2010-066774

(51) Int. Cl. F16G 1/10; F16G 1/04

(52) U.S. Cl. 474/205

(57) ABSTRACT

A toothed belt includes: a belt main body in which a plurality of cords are arranged side by side in a widthwise direction of a rubber layer; a plurality of teeth portions formed at one surface of the belt main body; and a tooth cloth covering surfaces of the teeth portions. A cloth base material is obtained by impregnating a surface layer rubber composition into an original canvas and by forming a surface layer, and an adhesion layer rubber composition is attached to one surface of the cloth base material to form an adhesion layer, thus forming the tooth cloth. The rubber layer contains: HNBR including HNBR in which a Mooney viscosity at 100° C. is in a range of from 100 to 160; and a polymer alloy obtained by finely dispersing zinc methacrylate in HNBR. The rubber layer and rubber compositions preferably contain hydrogenated carboxyl NBR.

### CROSS-REFERENCE TO RELATED APPLICATIONS

This Nonprovisional application claims priority under 35 U.S.C. §119(a) on Patent Application No. 2010-66774 filed in Japan on Mar. 23, 2010, the entire contents of which are hereby incorporated by reference.

### BACKGROUND

1. Technical Field

The present invention relates to toothed belts having high rigidity, high strength, and excellent bending fatigue resistance.

2. Description of Related Art

A toothed belt is stretched between a driving toothed pulley and a driven toothed pulley, and is used as a power transmission belt for general industry equipment and OA equipment, a timing belt for an automobile internal combustion engine, a driving belt for a bicycle, etc. Normally, a toothed belt includes: a belt main body formed of a carbon black-containing black rubber layer in which a plurality of cords are longitudinally embedded; a plurality of teeth portions formed at a surface of the belt main body; and a tooth cloth covering surfaces of the teeth portions. When tooth chipping has occurred mainly due to wearing out of the tooth cloth, and when the cord has been cut, for example, the toothed belt cannot be used.

In order to enhance power transmission performance, stopping accuracy and damping characteristic of the toothed belt, it is absolutely necessary to increase the strength, rigidity, wear resistance and bending fatigue resistance of the rubber layer, and the adhesion thereof to other materials.

In a known technique, a polymer alloy, in which zinc methacrylate is finely dispersed in hydrogenated nitrile rubber (HNBR), is mixed in a rubber layer composition, thereby making it possible to increase the strength, rigidity and wear resistance of a rubber layer (see Japanese Patent No. 4360993, for example). In this case, since no carbon has to be contained as a reinforcing agent, the light-colored rubber layer can be provided.

However, when the mixing ratio of zinc methacrylate to HNBR is increased with the aim of further enhancing the strength and the like, there occur disadvantages such as: degradation in bending fatigue resistance of the rubber layer, adhesion thereof to other materials, and permanent strain characteristic thereof, an increase in starting torque in cold climate areas and during wintertime (i.e., a reduction in low temperature resistance); and an increase in self-heating caused by belt operation, thus causing a problem that dynamic properties are mainly degraded.

Further, in order to enhance the power transmission performance of the toothed belt, it is absolutely necessary to increase wear resistance of a canvas used for the belt tooth cloth, and to increase adhesion thereof to the rubber layer and cords. Furthermore, in order to obtain cleanliness during operation and favorable maintainability, it is desired that the color of the canvas be lighter unlike a conventional solid black canvas, and a technique in which compatibility between lighter color and high wear resistance is achieved is also reported (see Japanese Patent No. 4360993, for example).

However, there arises a problem that conductivity of the tooth cloth is degraded due to its light color to cause charge and discharge during belt operation, and there also arises a problem that the adhesion of the tooth cloth to the rubber layer and cords is reduced when the amount of a friction-reducing agent such as polytetrafluoroethylene (PTFE) is increased with the aim of further enhancing the wear resistance.

Moreover, in order to enhance the power transmission performance, stopping accuracy and damping characteristic of the toothed belt, it is also absolutely necessary to increase the strength, rigidity and bending fatigue resistance of the cords, and the adhesion thereof to other materials.

A method of using carbon cords made of carbon fibers in an attempt to increase the rigidity of the cords has already been known.

Although the foregoing method is very effective in enhancing tooth jumping torque, stopping accuracy and damping characteristic by improvement in belt tensile rigidity, this method presents a problem that it is difficult to enhance the power transmission performance (i.e., it is difficult to narrow the width of the belt and to make the resulting apparatus compact in size), because tensile strength is not increased very much, bending fatigue resistance is low, shock resistance is low and it is hard to provide adhesion, when the carbon cords have the same diameters as those of conventional glass cords and aramid cords, and the carbon cords are compared with glass cords and aramid cords. With the aim of improving the power transmission performance, there is developed a cord in which a plurality of strands made of primarily-twisted glass fibers are disposed around a fiber core made of carbon fibers, and the fiber core and strands are finally twisted (see Japanese Patent No. 4018460).

However, the use of this cord presents a problem that since the adhesion of the cord to the rubber layer is bad, the teeth portion is chipped at an early stage upon application of a strong shearing force to the teeth portion of the belt, thus making it impossible to obtain expected performance.

### SUMMARY

The present invention has been made in view of the above-described circumstances, and its object is to provide a toothed belt having high rigidity, high strength, and favorable bending fatigue resistance by allowing a rubber layer to contain high molecular weight HNBR.

Another object of the present invention is to provide a toothed belt having favorable adhesion between a rubber layer and cords and between the rubber layer and a tooth cloth, and having favorable wear resistance by allowing the rubber layer to contain hydrogenated carboxyl NBR.

Still another object of the present invention is to provide a toothed belt having low temperature resistance and oil resistance in a balanced manner by allowing a rubber layer to contain low-binding acrylonitrile content HNBR.

Still yet another object of the present invention is to provide a toothed belt having favorable adhesion between a tooth cloth and a rubber layer and between the tooth cloth and cords by allowing a surface layer or adhesion layer of the tooth cloth to contain hydrogenated carboxyl NBR.

Another object of the present invention is to provide a toothed belt having favorable conductivity by allowing a surface layer of a tooth cloth to contain conductive zinc oxide and by allowing an adhesion layer of the tooth cloth to contain conductive carbon.

Still another object of the present invention is to provide a toothed belt having favorable shock resistance and bending fatigue resistance by using a cord made of a composite material of carbon fibers and glass fibers.

A toothed belt according to a first aspect of the present invention includes: a belt main body having a rubber layer which contains hydrogenated nitrile rubber, and a polymer alloy obtained by finely dispersing zinc methacrylate in a same type or different type of the hydrogenated nitrile rubber; a plurality of teeth portions formed at least at one surface of the rubber layer; and a tooth cloth in which an adhesion layer is formed at one surface of a cloth base material obtained by impregnating a surface layer rubber composition which contains hydrogenated nitrile rubber into a canvas, the tooth cloth being adhered to the belt main body so as to cover the teeth portions, wherein the rubber layer contains the hydrogenated nitrile rubber in which a Mooney viscosity at 100° C. is in a range of from 100 to 160.

A second aspect of the present invention, based on the first aspect, provides a toothed belt characterized in that the rubber layer has a rubber hardness Hs of 95 or more, a 100% modulus of 18 MPa or more in a vulcanized rubber test, and a rubber rupture strength of 36 MPa or more.

A third aspect of the present invention, based on the first aspect, provides a toothed belt characterized in that the rubber layer contains the hydrogenated nitrile rubber, in which a Mooney viscosity at 100° C. is in a range of from 100 to 160, in a range of from 5 to 20 mass percentage with respect to the total amount of the rubber layer.

According to the first to third aspects of the present invention, the rubber layer of the belt main body contains the high molecular weight hydrogenated nitrile rubber (HNBR) in which the Mooney viscosity is in a range of from 100 to 160; therefore, the toothed belt has high rigidity, high strength, and favorable bending fatigue resistance.

A fourth aspect of the present invention, based on any one of the first to third aspects, provides a toothed belt characterized in that the rubber layer further contains hydrogenated carboxyl nitrile rubber.

A fifth aspect of the present invention, based on the fourth aspect, provides a toothed belt characterized in that the rubber layer contains the hydrogenated carboxyl nitrile rubber in a range of from 1 to 30 mass percentage with respect to the total amount the rubber layer.

According to the fourth or fifth aspect of the present invention, since the rubber layer contains the hydrogenated carboxyl nitrile rubber (hydrogenated carboxyl NBR), the adhesion between the rubber layer and cords and between the rubber layer and tooth cloth is improved, and the wear resistance of the rubber layer is improved.

A sixth aspect of the present invention, based on any one of the first to fifth aspects, provides a toothed belt characterized in that the rubber layer contains low-binding acrylonitrile content hydrogenated nitrile rubber in which the content of binding acrylonitrile is in a range of from 15 to 25 mass percentage.

In the present invention, the toothed belt has favorable low temperature resistance.

A seventh aspect of the present invention, based on the sixth aspect, provides a toothed belt characterized in that the rubber layer contains the low-binding acrylonitrile content hydrogenated nitrile rubber in a range of from 10 to 70 mass percentage with respect to the total amount of rubber components of the rubber layer.

An eighth aspect of the present invention, based on the sixth aspect, provides a toothed belt characterized in that the rubber layer contains hydrogenated nitrile rubber in which the content of binding acrylonitrile is in a range of from 35 to 50 mass percentage and a mass ratio of this hydrogenated nitrile rubber and the low-binding acrylonitrile content hydrogenated nitrile rubber is in a range of from 15:85 to 80:20.

In the seventh or eighth aspect of the present invention, the toothed belt has low temperature resistance and oil resistance in a balanced manner.

A ninth aspect of the present invention, based on any one of the first to eighth aspects, provides a toothed belt characterized in that the surface layer rubber composition of the tooth cloth contains hydrogenated carboxyl nitrile rubber.

In the present invention, since the surface layer rubber composition of the tooth cloth contains hydrogenated carboxyl NBR, the adhesion of the tooth cloth to the rubber layer and cords is improved. Furthermore, no RFL (Resorcin Formalin Latex) process is necessary, and therefore, wear resistance is improved.

A tenth aspect of the present invention, based on any one of the first to ninth aspects, provides a toothed belt characterized in that the adhesion layer of the tooth cloth contains hydrogenated carboxyl nitrile rubber.

In the present invention, since the adhesion layer of the tooth cloth contains the hydrogenated carboxyl NBR, the adhesion of the tooth cloth to the rubber layer and cords is improved.

An eleventh aspect of the present invention, based on the ninth or tenth aspect, provides a toothed belt characterized in that the surface layer rubber composition contains polytetrafluoroethylene.

In the present invention, since the surface layer of the tooth cloth contains PTFE, wear resistance is improved. Furthermore, even when the tooth cloth is worn, a self-lubricating property is maintained.

A twelfth aspect of the present invention, based on any one of the first to eleventh aspects, provides a toothed belt characterized in that the surface layer rubber composition contains conductive zinc oxide.

In the present invention, the conductivity of the surface of the tooth cloth is improved.

A thirteenth aspect of the present invention, based on any one of the first to twelfth aspects, provides a toothed belt characterized in that the adhesion layer contains conductive carbon.

In the present invention, the conductivity of the surface of the tooth cloth is improved.

A fourteenth aspect of the present invention, based on any one of the first to thirteenth aspects, provides a toothed belt characterized in that the belt main body has a cord in which a plurality of strands made of primarily-twisted glass fibers are disposed around a fiber core made of carbon fibers, and the fiber core and strands are finally twisted.

In the present invention, the adhesion is further improved, and the toothed belt has more favorable rigidity, shock resistance and bending fatigue resistance.

According to the present invention, since the rubber layer contains high molecular weight HNBR, the toothed belt has high rigidity, high strength, and favorable bending fatigue resistance.

Further, according to the present invention, the rubber layer contains hydrogenated carboxyl NBR; hence, in the toothed belt, the adhesion of the rubber layer to the cords and tooth cloth is improved, and the wear resistance is improved.

In addition, according to the present invention, the rubber layer contains low-binding acrylonitrile content HNBR, and therefore, the toothed belt has low temperature resistance.

Furthermore, according to the present invention, since the surface layer or adhesion layer of the tooth cloth contains hydrogenated carboxyl NBR, the adhesion of the tooth cloth to the rubber layer and cords is improved.

Moreover, according to the present invention, since the surface layer of the tooth cloth contains conductive zinc oxide and the adhesion layer of the tooth cloth contains conductive carbon, the toothed belt has favorable conductivity.

Besides, according to the present invention, the cord made of a composite material of carbon fibers and glass fibers is used, and therefore, the toothed belt has favorable rigidity, shock resistance and bending fatigue resistance.

The above and further objects and features will more fully be apparent from the following detailed description with accompanying drawings.

### BRIEF DESCRIPTION OF THE SEVERAL VIEWS OF THE DRAWINGS

FIG. 1 is a partially broken perspective view illustrating a toothed belt according to an embodiment of the present invention;

FIG. 2A is a plan view illustrating the toothed belt;

FIG. 2B is a cross-sectional view illustrating the toothed belt;

FIG. 2C is a partially broken side view illustrating the toothed belt;

FIGS. 3A to 3D are schematic cross-sectional views for describing a method for fabricating the toothed belt;

FIG. 4 is a schematic diagram illustrating an apparatus for evaluating bending fatigue resistance of a rubber layer;

FIG. 5 is a graph illustrating time elapsed before occurrence of a minute crack at a rear portion of the rubber layer for each toothed belt;

FIG. 6 is a graph illustrating an amount of change in rubber layer thickness of a belt main body upon lapse of 1000 hours for each toothed belt;

FIG. 7 is a schematic diagram illustrating an apparatus for evaluating low temperature resistance;

FIG. 8 is a graph illustrating results of an examination conducted on a relationship between the number of cycles and the number of rear rubber cracks for each toothed belt;

FIG. 9 is a graph illustrating results of an examination conducted on a relationship between immersion time and volume change rate;

FIG. 10 is a diagram for describing a method for evaluating the adhesion between each rubber layer material and a tooth cloth;

FIG. 11 is a graph illustrating adhesion strength of the rubber layer material of each blending example when the adhesion strength of the rubber layer material of Blending example 4 is determined as 100%;

FIG. 12 is a diagram for describing a method for evaluating the adhesion between each rubber layer material and a cord;

FIG. 13 is a graph illustrating evaluation results on the adhesion strength of the respective rubber layer materials, each obtained with the use of a cord 1;

FIG. 14 is a graph illustrating evaluation results on the adhesion strength of the respective rubber layer materials, each obtained with the use of a cord 2;

FIG. 15 is a graph illustrating evaluation results on the adhesion strength of the respective rubber layer materials, each obtained with the use of a cord 3;

FIG. 16 is a schematic diagram illustrating an apparatus for evaluating conductivity;

FIG. 17 is a graph illustrating generated static electricity amounts;

FIG. 18 is a graph illustrating generated static electricity amounts;

FIGS. 19A to 19C are diagrams for describing a method for controlling exposure of an adhesion layer;

FIG. 20 is a graph illustrating adhesion strength of each tooth cloth when the adhesion strength of a tooth cloth 6 is determined as 100%;

FIG. 21 is a diagram for describing a method for evaluating adhesion between each tooth cloth and cord;

FIG. 22 is a graph illustrating adhesion strength of each tooth cloth to the cords 1 to 3 when the adhesion strength provided by a combination of the tooth cloth 6 and the cord 3 is determined as 100%;

FIG. 23 is a graph illustrating an amount of wear of a tooth cloth upon lapse of 1000 hours in each toothed belt;

FIG. 24 is a schematic diagram illustrating an apparatus for evaluating shock resistance;

FIG. 25 is a graph illustrating time elapsed before occurrence of failure in each toothed belt;

FIG. 26 is a graph illustrating residual strength upon lapse of 1000 hours in each toothed belt;

FIG. 27 is a schematic diagram illustrating an apparatus for evaluating load durability;

FIG. 28 is a graph illustrating time elapsed before occurrence of failure in each toothed belt;

FIG. 29 is a schematic diagram illustrating an apparatus for evaluating belt damping characteristics; and

FIG. 30 is a graph illustrating relationships between damping time and driven pulley oscillation amount.

### DETAILED DESCRIPTION

Hereinafter, the present invention will be specifically described with reference to the drawings illustrating an embodiment thereof.

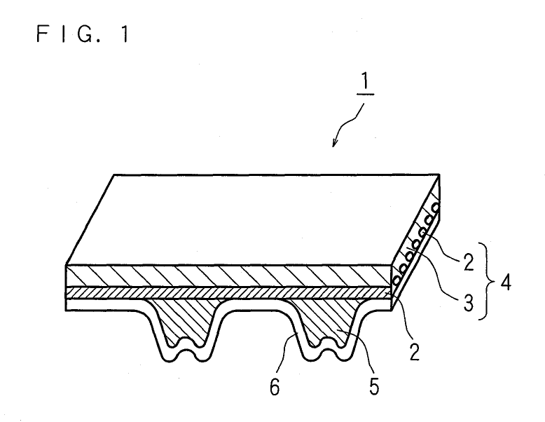

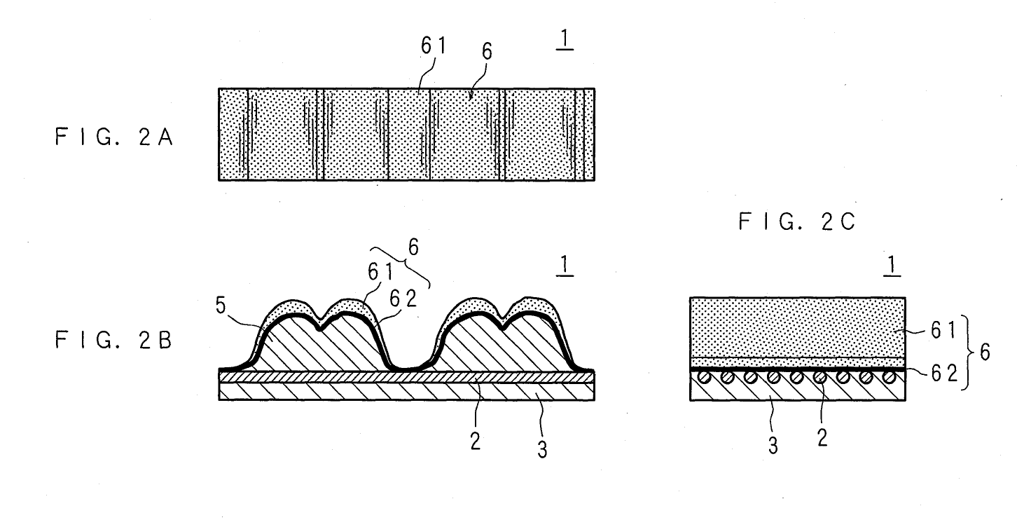

FIG. 1 is a partially broken perspective view illustrating a toothed belt 1 according to the embodiment of the present invention, FIG. 2A is a plan view illustrating the toothed belt 1, FIG. 2B is a cross-sectional view illustrating the toothed belt 1, and FIG. 2C is a partially broken side view illustrating the toothed belt 1.

The toothed belt 1 includes: a belt main body 4 in which a plurality of cords 2 are arranged side by side in a width direction of a rubber layer 3; a plurality of teeth portions 5 formed at one surface of the belt main body 4; and a tooth cloth 6 covering surfaces of the teeth portions 5. In the toothed belt 1, the teeth portions 5 may be formed at both of top and bottom surfaces of the belt main body 4.

The tooth cloth 6 is provided as follows. A cloth base material 61 is obtained by impregnating a surface layer rubber composition into an original canvas, and by forming a surface layer at a surface of the original canvas. And an adhesion layer rubber composition is attached to a surface of the cloth base material 61, which is adjacent to the teeth portions 5, thereby forming an adhesion layer 62 to provide the tooth cloth 6.

(1) Belt Main Body

The rubber layer 3 included in the belt main body 4 contains the following rubber components: HNBR; and an HNBR/zinc methacrylate polymer alloy (hereinafter referred to as a “polymer alloy”) obtained by finely dispersing zinc methacrylate in HNBR. The polymer alloy may be provided by using a product prepared in advance, or may be prepared by finely dispersing zinc methacrylate in HNBR at a preparation stage for a composition for the rubber layer 3 (i.e., a rubber layer composition). Examples of the product include “Zeoforte (registered trademark) ZSC2295N” and “Zeoforte ZSC4195CX” which are produced by ZEON CORPORATION.

In single HNBR, the content of binding acrylonitrile is preferably 15% to 50%, and an iodine value is preferably 60 mg/100 mg or less. Further, the HNBR includes high molecular weight HNBR in which a Mooney viscosity (1+4) at 100° C. is greater than or equal to 100 and less than or equal to 160. The Mooney viscosity is preferably greater than or equal to 110 and less than or equal to 150, and is more preferably greater than or equal to 120 and less than or equal to 140. Combined with the inclusion of the polymer alloy, the inclusion of the high molecular weight HNBR makes it possible to allow the rubber layer 3 to have high strength, high rigidity and favorable bending fatigue resistance. In other words, since it is possible to allow the rubber layer 3 to have high strength and high rigidity without increasing the content of the polymer alloy, the above-described adverse effect, such as degradation in bending fatigue resistance due to an increase in the content of the polymer alloy, will not occur. The reason for improvements in the strength, rigidity and dynamic properties of the rubber layer by addition of the high molecular weight HNBR is believed to be due to the fact that binding force of polymeric molecules themselves and intermolecular binding force are improved, thus achieving effects such as reduction in permanent strain and reduction in self-heating. In terms of favorable realization of the foregoing effects and in terms of cost, the mass percentage of the high molecular weight HNBR with respect to the total amount of the rubber layer 3 (rubber layer composition) is preferably in a range of from 5 to 20%, more preferably in a range of from 7 to 18%, and even more preferably in a range of from 10 to 15%.

As a rubber component, hydrogenated carboxyl NBR obtained by hydrogenating carboxyl nitrile rubber is preferably further contained. Thus, the cords 2 are adhered to the inside of the rubber layer 3 in a favorable manner, the adhesion between the rubber layer 3 and the tooth cloth 6 is improved, and wear resistance of the rubber layer 3 is improved. The reason for improvement in the wear resistance of the rubber layer by introduction of carboxyl is believed to be due to the fact that polymeric intermolecular binding force is improved. The reason for improvements in wettability and adhesion to other materials such as the tooth cloth and cords by introduction of carboxyl is believed to be due to the fact that polarity appropriate to each material is given and the amount of primary binding of the other materials to an adhesive is increased.

In the hydrogenated carboxyl NBR, a Mooney viscosity (1+4) at 100° C. is preferably greater than or equal to 60 and less than or equal to 100, the content of binding acrylonitrile is preferably 50 mass percentage or less, and an iodine value is preferably 60 mg/100 mg or less. In terms of favorable realization of the foregoing effects and in terms of cost, the mass percentage of the hydrogenated carboxyl NBR with respect to the total amount of the rubber layer 3 is preferably in a range of from 1 to 30%, more preferably in a range of from 2 to 10%, and even more preferably in a range of from 2.5 to 5%.

Further, HNBR (low-binding acrylonitrile content HNBR) in which the content of binding acrylonitrile is in a range of from 15 to 25 mass percentage with respect to the total amount of HNBR is preferably contained in the rubber components. Thus, the toothed belt 1 has favorable low temperature resistance (low temperature startability). In the low-binding acrylonitrile content HNBR, a Mooney viscosity (1+4) at 100° C. is more preferably greater than or equal to 50 and less than or equal to 100, and an iodine value is more preferably 27 mg/100 mg or less. In terms of favorable realization of the foregoing effects and in terms of cost, the mass percentage of the low-binding acrylonitrile content HNBR with respect to the total amount of the rubber components is preferably in a range of from 10 to 70%, more preferably in a range of from 20 to 50%, and even more preferably in a range of from 30 to 40%. Thus, suitable polarity is given to the toothed belt 1, and the toothed belt 1 has low temperature resistance (low temperature startability) and oil resistance in a balanced manner. In this embodiment, each HNBR may be single polymer, or may be HNBR contained in a polymer alloy.

Furthermore, a mass ratio between high-binding or medium-binding acrylonitrile content HNBR, in which the content of binding acrylonitrile is in a range of from 35 to 50 mass percentage, and the low-binding acrylonitrile content HNBR, in the rubber components is preferably 15:85 to 80:20, more preferably 30:70 to 70:30, and even more preferably 50:50 to 65:35.

Substances such as a cross-linking agent including organic peroxide and/or sulfur, a co-cross-linking agent (cross-linking assistant), an age resister, a pigment, a coloring agent and a plasticizer are mixed in the foregoing rubber components, thus obtaining the rubber layer composition. And the rubber layer 3 is obtained by cross-linking of the rubber layer composition. The organic peroxide is not particularly limited, but usable examples of the organic peroxide include:
1,1-di-t-butylperoxy-3,3,5-trimethylcyclohexane;
di-t-butylperoxide;
dibutylcumyl peroxide;
dicumyl peroxide;
2,5-dimethyl-2,5-di(t-butylperoxy)hexane;
2,5-dimethyl-2,5-di(t-butylperoxy)hexyne;
1,3-bis(t-butylperoxyisopropyl)benzene; and
t-butylperoxyisopropylcarbonate.
   Furthermore, as the cross-linking agent, a suitable amount of oxime-nitroso compound, monomers or polymers, generally used as a co-cross-linking agent, may be added in addition to the foregoing examples of the organic peroxide. The rubber layer composition may further contain a reinforcing agent, an agent for preventing surface cracking, etc.

Examples of the co-cross-linking agent include phenylenedimaleimide, ethylene dimethacrylate, and triallyl isocyanurate.

Examples of the age resister include an amine age resister, and 2-mercaptobenzimidazole zinc salt.

Examples of the pigment and coloring agent include titanium oxide, carbon, phthalocyanine blue, phthalocyanine green, and carmine red.

Examples of the plasticizer include adipic acid polyester, trimellitate, and aliphatic diacid ester plasticizers.

In each cord 2, a fiber core is preferably located at its center portion around which a plurality of first-twisted strands are preferably disposed, and the fiber core and strands are preferably second-twisted. It is more preferable that the first twist direction of the strands be identical to the second twist direction thereof and the core fibers be first-twisted in a direction opposite to the first twist direction of the strands or be non-twisted. It is even more preferable to use carbon fibers as the fiber core and to use glass fibers as the strands.

The rubber layer composition according to the present invention has the above-described composition; therefore, even when the rubber layer 3 obtained by cross-linking of the rubber layer composition contains no carbon as a reinforcing agent, there are provided physical properties such as high strength and high hardness, e.g., “a rubber hardness Hs of 95 or more, a 100% modulus of 18 MPa or more in a vulcanized rubber test, and a rubber rupture strength of 36 MPa or more”. Accordingly, the rubber layer 3 can be colored with a color other than black, and thus has cleanliness since contamination will not be conspicuous unlike the case where the rubber layer 3 is colored with black using carbon and the belt main body 4 is worn to scatter wear powder. Furthermore, due to the resulting light color, visual identification of generation of wear powder is facilitated, and the timing of replacement can be easily determined, thus also providing favorable maintainability. Note that the foregoing rubber hardness Hs is preferably 98 Hs or less in terms of noise control.

(2) Tooth Cloth

Examples of the original canvas for the tooth cloth 6 include nylon 6, nylon 66, nylon 46, aramid fiber, and polyparaphenylene benzoxazole fiber. These substances may be singly used, or may be formed with mix-woven threads.

The surface layer rubber composition and adhesion layer rubber composition of the tooth cloth 6 contain the following rubber components: HNBR; and a HNBR/zinc methacrylate polymer alloy obtained by finely dispersing zinc methacrylate in HNBR. The polymer alloy may be provided by using a product prepared in advance, or may be prepared by finely dispersing zinc methacrylate in HNBR at a preparation stage for the surface layer rubber composition or the adhesion layer rubber composition.

As a rubber component, hydrogenated carboxyl NBR is preferably further contained. Examples of the hydrogenated carboxyl NBR include one in which a Mooney viscosity (1+4) at 100° C. is greater than or equal to 60 and less than or equal to 100, the content of binding acrylonitrile is 50% or less, and an iodine value is 60 mg/100 mg or less. The adhesion of the tooth cloth 6 to the cords 2 and the rubber layer 3 is improved by containing the hydrogenated carboxyl NBR. Further, no RFL process is necessary, and a condensation compound of resorcin and formalin is not contained, thus providing favorable wear resistance. Even when the hydrogenated carboxyl NBR is mixed only in the adhesion layer rubber composition, the above-described effects are achieved. The reason for improvement in the adhesion of the tooth cloth 6 to the other materials by introduction of carboxyl is believed to be due to the fact that polarity appropriate to each material is given and the amount of primary binding of the other materials to an adhesive is increased. In terms of favorable realization of the foregoing effects and in terms of workability and cost, the mass percentage of the hydrogenated carboxyl NBR with respect to the surface layer rubber composition or the adhesion layer rubber composition is preferably in a range of from 1 to 30%, more preferably in a range of from 2 to 15%, and even more preferably in a range of from 2.5 to 10%.

Moreover, substances such as a cross-linking agent including the foregoing organic peroxide, a cross-linking assistant including stearic acid and/or phenylenedimaleimide, a reinforcing agent including potassium titanate whisker, an NBR adhesive including phenol resin, and a plasticizer including adipic acid polyester are mixed as components other than the rubber components. A pigment such as titanium oxide may be mixed. In such a case, since a reinforcing agent such as potassium titanate whisker is contained, no carbon has to be contained as a reinforcing agent; therefore, the tooth cloth 6 can be colored with a color such as white, and thus has cleanliness since contamination will not be conspicuous unlike the case where the tooth cloth 6 is colored with black using carbon and the tooth cloth 6 is worn to scatter wear powder.

In the surface layer rubber composition, PTFE is further mixed. Since adhesive force is improved by the hydrogenated carboxyl NBR, a large amount of PTFE can be contained, and the wear resistance of the tooth cloth 6 can be further improved. The mixed content of PTFE with respect to the surface layer rubber composition is preferably in a range of from 30 to 90 mass percentage, more preferably in a range of from 40 to 80 mass percentage, and even more preferably in a range of from 50 to 60 mass percentage. PTFE is contained not only in the surface layer of the tooth cloth 6 but also in the cloth base material 61, and therefore, a self-lubricating property is maintained even when the tooth cloth 6 is worn.

Further, conductive zinc oxide is preferably mixed in the surface layer rubber composition. In the conductive zinc oxide, a volume resistivity is more preferably greater than or equal to 20 Ω·cm and less than or equal to 500 Ω·cm, a specific surface area is more preferably greater than or equal to 4 m²/g and less than or equal to 50 m²/g, a primary particle size is more preferably greater than or equal to 20 nm and less than or equal to 250 nm, and a bulk specific gravity is more preferably greater than or equal to 200 ml/100 g and less than or equal to 1000 ml/100 g. Furthermore, in terms of obtainment of favorable conductivity and in terms of cost, the mass percentage of the conductive zinc oxide in the surface layer rubber composition is preferably in a range of from 2 to 20%, and is more preferably in a range of from 3 to 10%.

Conductive carbon is preferably mixed in the adhesion layer rubber composition. In the conductive carbon, an average particle diameter is more preferably greater than or equal to 20 nm and less than or equal to 50 nm, a specific surface area is more preferably greater than or equal to 30 m²/g and less than or equal to 140 m²/g, an iodine absorption amount is more preferably greater than or equal to 50 mg/g and less than or equal to 180 mg/g, a bulk density is more preferably greater than or equal to 0.01 g/ml and less than or equal to 0.3 g/ml, and an electric resistivity is more preferably less than or equal to 0.4 Ω·cm. In terms of obtainment of favorable conductivity and in terms of workability and cost, the mass percentage of the conductive carbon in the adhesion layer rubber composition is preferably in a range of from 10 to 40%, more preferably in a range of from 12 to 30%, and even more preferably in a range of from 13 to 20%.

The degree of exposure of conductive materials such as conductive zinc oxide and conductive carbon from the surface of the tooth cloth 6 (i.e., the surface of the toothed belt 1) is controllable as will be described later. Thus, the tooth cloth 6 has favorable conductivity, and charging during operation of the toothed belt 1 is prevented. The degree of exposure is preferably greater than or equal to 0% and less than or equal to 30% with respect to the entire surface.

The surface layer rubber composition and adhesion layer rubber composition are each used by being dissolved in an organic solvent.

(3) Fabrication of Toothed Belt

Hereinafter, a method for fabricating the toothed belt 1 will be described.

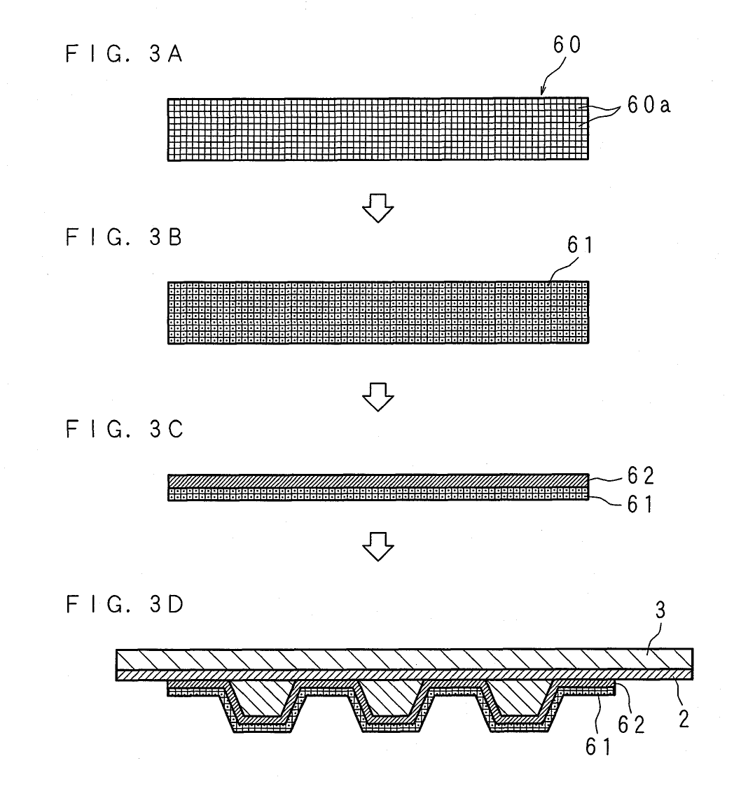

FIGS. 3A to 3D are schematic cross-sectional views for describing a method for fabricating the toothed belt 1.

First, an original canvas 60 made of nylon 66, for example, is immersed in a solution in which the surface layer rubber composition is dissolved in an organic solvent, and the original canvas 60 is then dried (FIG. 3A).

Thus, the surface layer rubber composition (indicated by •• in the diagrams) is penetrated into grain 60a of the original canvas 60, and the cloth base material 61, on a surface of which a surface layer is formed by the surface layer rubber composition, is obtained (FIG. 3B). As a solid content after drying, 50 g to 200 g of the surface layer is formed per square meter of the original canvas 60.

Next, a solution, in which the adhesion layer rubber composition is dissolved in an organic solvent, is applied to one surface of the cloth base material 61 and is then dried, thereby forming the adhesion layer 62 (FIG. 3C). As a solid content after drying, 30 g to 250 g of the adhesion layer 62 is formed per square meter of the original canvas 60.

Then, the tooth cloth 6 is wrapped around an outer surface of a cylindrical die, having grooves for formation of the teeth portions, so that a cross-linking film is formed in a region adjacent to the cylindrical die, and the cords 2 are spirally wrapped therearound with a given tension. Moreover, an unvulcanized (uncross-linked) rubber sheet made of the rubber layer rubber composition is wrapped therearound; then, the resulting article is put into a vulcanizer, pressurized from its outer periphery, and heated with steam. A molding temperature is higher than or equal to 100° C. and less than or equal to 130° C., a molding pressure is greater than or equal to 6 MPa and less than or equal to 10 MPa. In the toothed belt 1, due to the pressurization and heating, rubber is softened to form the teeth portions 5, the tooth cloth 6 is adhered to the surface side of the teeth portions 5, and rubber is vulcanized to form the rubber layer 3. As a result, the toothed belt 1 is fabricated (FIG. 3D).

### EXAMPLES

Hereinafter, examples of the present invention will be specifically described, but the present invention is not limited to these examples.

### (1) Rubber Layer Composition of Belt Main Body

### Blending Example 1

In accordance with a blending example (indicated by parts by mass) illustrated in Table 1 below, the rubber layer composition of Blending example 1 was obtained by blending the following substances: HNBR (1) (“Zetpol (registered trademark) 2010H” produced by ZEON CORPORATION); an HNBR/zinc methacrylate polymer alloy (polymer alloy) (1) (“Zeoforte ZSC2295N” produced by ZEON CORPORATION); titanium oxide (“titanium oxide R-62N” produced by Sakai Chemical Industry Co., Ltd. [white pigment]); a plasticizer (“ADK CIZER C9N” produced by ADEKA CORPORATION [adipic acid polyester]); a cross-linking agent (“Perkadox 14/40C” produced by Kayaku Akzo Corporation [1,3-bis(t-butylperoxyisopropyl)benzene (40%)+calcium carbonate]); a co-cross-linking agent (“VULNOC PM” produced by OUCHI SHINKO CHEMICAL INDUSTRIAL CO., LTD. [phenylenedimaleimide]); an age resister (“NAUGARD 445” produced by Shiraishi Calcium Kaisha, Ltd. [amine age resister], and “NOCRAC MBZ” produced by OUCHI SHINKO CHEMICAL INDUSTRIAL CO., LTD. [2-mercaptobenzimidazole zinc salt]); and SRF carbon (produced by ASAHI CARBON CO., LTD. [coloring agent]).

“Zetpol 2010H” has the following physical properties: a binding acrylonitrile content of 36.2 mass percentage, an iodine value (central value) of 11 mg/100 mg, and a Mooney viscosity of 120 or more. A base polymer for “ZSC2295N” is “Zetpol 2020” having the following physical properties: a binding acrylonitrile content of 36.2 mass percentage, an iodine value (central value) of 28 mg/100 mg, and a Mooney viscosity of 78. “ZSC2295N” has the following physical properties: a Mooney viscosity of 85 and a JIS hardness (shore D) of 95 (60).

TABLE 1

| | BLEND- | BLEND- | BLEND- | BLEND- |
|---|---|---|---|---|
| | ING | ING | ING | ING |
| | EXAM- | EXAM- | EXAM- | EXAM- |
| COMPONENT | PLE 1 | PLE 2 | PLE 3 | PLE 4 |
| HNBR (1) | 15.0 | 15.0 | 10.0 | — |
| HNBR (2) | — | — | — | 15.0 |
| HNBR/ZINC | 85.0 | — | — | 85.0 |
| METHACRYLATE | | | | |
| POLYMER ALLOY (1) | | | | |
| HNBR/ZINC | — | 85.0 | 85.0 | — |
| METHACRYLATE | | | | |
| POLYMER ALLOY (2) | | | | |
| HYDROGENATED | — | — | 5.0 | — |
| CARBOXYL NBR | | | | |
| TITANIUM OXIDE | 10.0 | 10.0 | 10.0 | 10.0 |
| PLASTICIZER | 6.0 | 6.0 | 6.0 | 6.0 |
| CROSS-LINKING | 8.0 | 8.0 | 8.0 | 8.0 |
| AGENT | | | | |
| CO-CROSS-LINKING | 0.5 | 0.5 | 0.5 | 0.5 |
| AGENT | | | | |
| AGE RESISTER | 2.0 | 2.0 | 2.0 | 2.0 |
| SRF CARBON | 1.0 | 1.0 | 1.0 | 1.0 |
| TOTAL | 127.5 | 127.5 | 127.5 | 127.5 |

### Blending Example 2

The rubber layer composition of Blending example 2 was obtained similarly to that of Blending example 1 except that a polymer alloy (2) (“ZSC4195CX” produced by ZEON CORPORATION) was blended instead of the polymer alloy (1). A base polymer for “ZSC4195CX” is “Zetpol 4310” having the following physical properties: a binding acrylonitrile content of 18.6 mass percentage, an iodine value (central value) of 15 mg/100 mg, and a Mooney viscosity of 80. “ZSC4195CX” has the following physical properties: a Mooney viscosity of 75 and a JIS hardness (shore D) of 95 (60).

### Blending Example 3

The rubber layer composition of Blending example 3 was obtained similarly to that of Blending example 2 except that the mixed content of the HNBR (1) was 10.0 parts by mass instead of 15.0 parts by mass, and 5 mass parts of hydrogenated carboxyl NBR (“Therban XT” produced by LANXESS K.K. CORPORATION) was blended.

### Blending Example 4

The rubber layer composition of Blending example 4 was obtained similarly to that of Blending example 1 except that HNBR (2) (“Zetpol 2020” produced by ZEON CORPORATION) was blended instead of the HNBR (1).

### (2) Surface Layer Rubber Composition and Adhesion Layer Rubber Composition of Tooth Cloth

### Blending Example I

In accordance with a blending example (indicated by parts by mass) illustrated in Table 2 below, the surface layer rubber composition of Blending example I was obtained by blending the following substances: the HNBR (2) (“Zetpol 2020”); the polymer alloy (1) (“ZSC2295N”); the hydrogenated carboxyl NBR (“Therban XT”); the titanium oxide (“titanium oxide R-62N”); the cross-linking agent (“Perkadox 14/40C”); the co-cross-linking agent (“VULNOC PM” [cross-linking assistant]); potassium titanate whisker (“TISMO D101” produced by Otsuka Chemical Co., Ltd.); phenol resin (“SUMILITERESIN PR7031A” produced by Sumitomo Bakelite Co., Ltd. [HNBR adhesive]); conductive zinc oxide (“zinc oxide 23-K” produced by HakusuiTech Co., Ltd.); the plasticizer (“ADK CIZER C9N”); and PTFE (“Zonyl MP1100” produced by DuPont Kabushiki Kaisya).

TABLE 2

| | SURFACE LAYER | | ADHESION LAYER | | |
|---|---|---|---|---|---|
| | BLENDING | BLENDING | BLENDING | BLENDING | BLENDING |
| COMPONENT | EXAMPLE I | EXAMPLE II | EXAMPLE A | EXAMPLE B | EXAMPLE C |
| HNBR (2) | 70.0 | 80.0 | 80.0 | 70.0 | 80.0 |
| HNBR/ZINC METHACRYLATE POLYMER ALLOY (1) | 20.0 | 20.0 | 20.0 | 20.0 | 20.0 |
| HYDROGENETED CARBOXYL NBR | 10.0 | — | — | 10.0 | — |
| TITANIUM OXIDE | 10.0 | 10.0 | 10.0 | 10.0 | 10.0 |
| CROSS-LINKING AGENT | 6.0 | 6.0 | 6.0 | 6.0 | 6.0 |
| CROSS-LINKING ASSISTANT | 1.0 | 1.0 | 1.0 | 1.0 | 1.0 |
| POTASSIUM TITANATE WHISKER | 5.0 | 5.0 | 5.0 | 5.0 | 5.0 |
| PHENOL RESIN | 20.0 | 20.0 | 20.0 | 20.0 | 20.0 |
| CONDUCTIVE ZINC OXIDE | 10.0 | — | — | — | — |
| CONDUCTIVE CARBON | — | — | 30.0 | 30.0 | — |
| PLASTICIZER | 4.0 | 4.0 | 8.0 | 8.0 | 4.0 |
| PTFE | 80.0 | 80.0 | — | — | — |
| TOTAL | 236.0 | 226.0 | 180.0 | 180.0 | 146.0 |

### Blending Example II

The surface layer rubber composition of Blending example II was obtained similarly to that of Blending example I except that the mixed content of the HNBR (2) was 80.0 parts by mass instead of 70.0 parts by mass and neither hydrogenated carboxyl NBR nor conductive zinc oxide was blended.

### Blending Example A

The adhesion layer rubber composition of Blending example A was obtained similarly to that of Blending example II except that the mixed content of the plasticizer was 8.0 parts by mass instead of 4.0 parts by mass, no PTFE was blended and conductive carbon was blended.

### Blending Example B

The adhesion layer rubber composition of Blending example B was obtained similarly to that of Blending example A except that the mixed content of the HNBR (2) was 70.0 parts by mass instead of 80.0 parts by mass and the hydrogenated carboxyl NBR (“Therban XT”) was blended.

### Blending Example C

The adhesion layer rubber composition of Blending example C was obtained similarly to that of Blending example A except that the mixed content of the plasticizer was 4.0 parts by mass instead of 8.0 parts by mass and no conductive carbon was mixed.

### (3) Tooth Cloth

In accordance with each combination illustrated in Table 3 below, the surface layer rubber composition of Blending example I or II was impregnated into an original canvas, and a surface layer was formed at its surface, thereby obtaining a cloth base material; then, an adhesion layer was formed on one surface of the cloth base material by the adhesion layer rubber composition of one of Blending examples from A to C, thereby obtaining tooth cloths 1 to 6. As the original canvas, a canvas made of nylon 66 with “2/2 twilled” was used.

TABLE 3

| | TOOTH | TOOTH | TOOTH | TOOTH | TOOTH | TOOTH |
|---|---|---|---|---|---|---|
| | CLOTH | CLOTH | CLOTH | CLOTH | CLOTH | CLOTH 6 |
| | 1 | 2 | 3 | 4 | 5 | |
| SURFACE | I | I | I | II | II | II |
| LAYER | | | | | | |
| ADHESION | A | B | C | A | B | C |
| LAYER | | | | | | |

### (4) Cord

The cords used in the examples are illustrated in Table 4 below.

TABLE 4

| | ORIGINAL YARN | PROCESS | CONSTITUTION |
|---|---|---|---|
| CORD 1 | CARBON FIBER + | HNBR | — |
| | GLASS FIBER | SYSTEM | |
| | COMPLEX | | |
| CORD 2 | CARBON FIBER | RFL | — |
| CORD 3 | K-GLASS FIBER 9 μm | RFL | 3/13 |

As a cord 1 illustrated in Table 4, a cord produced by Nippon Sheet Glass Co., Ltd. was used. This cord is formed as follows: a plurality of strands made of first-twisted glass fibers are located around a fiber core made of carbon fibers, and the fiber core and strands are second-twisted in the direction identical to the first twist direction of the strands so as to be integrated, thus forming the cord. The fiber core is first-twisted in a direction opposite to the first twist direction of the strands. The cord 1 is processed by a processing material including HNBR.

As a cord 2, a conventional cord produced by Nippon Sheet Glass Co., Ltd. was used. This cord is formed as follows: carbon fibers are first-twisted, a plurality of these fibers are second-twisted in a bundle so as to be integrated, and an RFL process is performed thereon, thereby forming the cord.

As a cord 3, a conventional cord produced by Nippon Sheet Glass Co., Ltd. was used. This cord is formed as follows: K-glass fibers are first-twisted, a plurality of these fibers are second-twisted in a bundle so as to be integrated, and an RFL process is performed thereon, thereby forming the cord.

### (5) Toothed Belt

### Example 1

As illustrated in Table 5 below, the rubber layer composition of Blending example 1 illustrated in Table 1 was used as a rubber layer of a belt main body, the tooth cloth 2 illustrated in Table 3 was used as a tooth cloth, and the cord 1 illustrated in Table 4 was used as a cord, thus fabricating a toothed belt according to Example 1.

### Example 2, Example 3, and Comparative Example 1

In accordance with combinations of rubber layers, tooth cloths and cords illustrated in Table 5 below, toothed belts according to Examples 2 and 3 and Comparative Example 1 were fabricated.

TABLE 5

| | | | | COMPAR- |
|---|---|---|---|---|
| | | | | ATIVE |
| | EXAM- | EXAM- | EXAM- | EXAM- |
| | PLE 1 | PLE 2 | PLE 3 | PLE 1 |
| RUBBER | BLENDING | BLENDING | BLENDING | BLENDING |
| LAYER | EXAM- | EXAM- | EXAM- | EXAM- |
| | PLE 1 | PLE 2 | PLE 3 | PLE 4 |
| TOOTH | 2 | 2 | 2 | 2 |
| CLOTH | | | | |
| CORD | 1 | 1 | 1 | 1 |

### Example 4 to 11

In accordance with combinations of rubber layers, tooth cloths and cords illustrated in Table 6 below, toothed belts according to Examples 4 to 11 were fabricated.

TABLE 6

| | EXAMPLE 4 | EXAMPLE 5 | EXAMPLE 6 | EXAMPLE 7 | EXAMPLE 8 | EXAMPLE 9 | EXAMPLE 10 | EXAMPLE 11 |
|---|---|---|---|---|---|---|---|---|
| RUBBER | BLENDING | BLENDING | BLENDING | BLENDING | BLENDING | BLENDING | BLENDING | BLENDING |
| LAYER | EXAMPLE 3 | EXAMPLE 3 | EXAMPLE 3 | EXAMPLE 3 | EXAMPLE 3 | EXAMPLE 3 | EXAMPLE 3 | EXAMPLE 3 |
| TOOTH | 1 | 2 | 3 | 4 | 5 | 6 | 2 | 2 |
| CLOTH | | | | | | | | |
| CODE | 1 | 1 | 1 | 1 | 1 | 1 | 2 | 3 |

### (6) Performance Evaluation

Hereinafter, performance evaluation results will be described.

### (a) EVALUATION OF STRENGTH AND RIGIDITY OF RUBBER LAYER

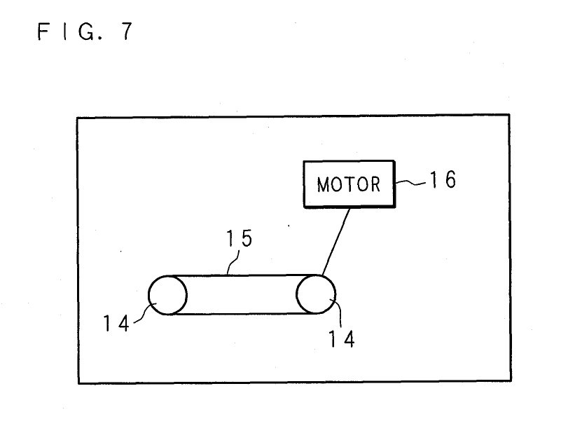

The rubber layer composition of each blending example of Table 1 was cross-linked at 160° C. for 25 minutes, and a rubber layer material (sheet) was thus fabricated to measure a rubber rupture strength (JIS K 6251 [Dumbbell No. 3]), a 100% modulus (JIS K 6254 [Strip-Shaped No. 1]), and a rubber hardness (JIS K 6253 [durometer hardness “Type A”]). Results of the measurement are illustrated in FIG. 7 below.

TABLE 7

| | BLEND- | BLEND- | BLEND- | BLEND- |
|---|---|---|---|---|
| | ING | ING | ING | ING |
| | EXAM- | EXAM- | EXAM- | EXAM- |
| | PLE 1 | PLE 2 | PLE 3 | PLE 4 |
| RUBBER RUPTURE | 42.6 | 41.6 | 41.1 | 35.3 |
| STRENGTH (MPa) | | | | |
| 100% MODULUS (MPa) | 22.4 | 21.8 | 21.6 | 16.7 |
| RUBBER | 97 | 97 | 96 | 94 |
| HARDNESS (Hs) | | | | |

It can be seen from Table 7 that strength and rigidity of the rubber layer material of each of Blending examples 1 to 3, containing HNBR “Zetpol 2010H” having a high Mooney viscosity (high molecular weight), are higher than those of the rubber layer material of Blending example 4 containing no high molecular weight HNBR. It can also be seen that the rubber layer material of Blending example 1 containing the polymer alloy (1) has the highest strength.

### (b) EVALUATION OF BENDING FATIGUE RESISTANCE OF RUBBER LAYER

For each of the toothed belts of Examples 1 to 3 and Comparative Example 1 described above, measurement was made on time of occurrence of a minute crack at a rear portion of the rubber layer of the belt main body.

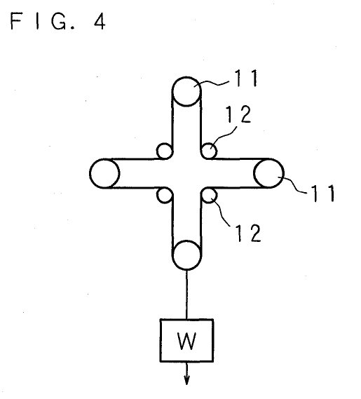

FIG. 4 is a schematic diagram illustrating an apparatus for evaluating the bending fatigue resistance of the rubber layer.

A load is imposed in a state where the teeth portions of each toothed belt are stretched across four pulleys 11, 11, 11, 11, and the rear portion of the belt main body is supported by four idlers 12, 12, 12, 12.

Measurement conditions are as follows.
Belt: Tooth Pitch of 8 mm, Length of 1000 mm, and Width of 20 mm
Pulley: 20 T (Diameter of 51 mm)×4
Idler Diameter: Diameter of 40 mm
Rotation Speed: 5500 r/min
Load: 197 N

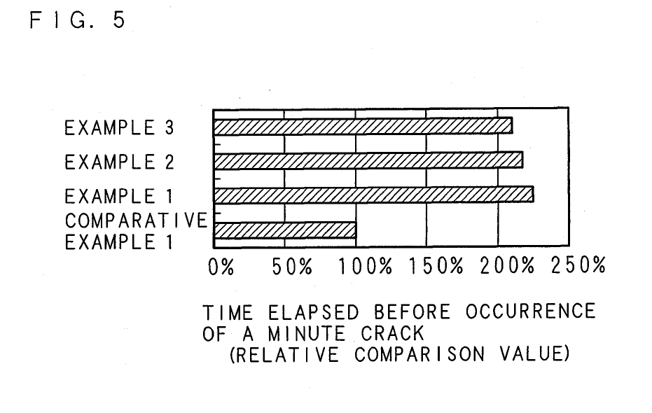

FIG. 5 is a graph illustrating time elapsed before occurrence of a minute crack at the rear portion of the rubber layer for each toothed belt. The elapsed time in Comparative Example 1 is determined as 100%.

It can be seen from FIG. 5 that the bending fatigue resistance of the toothed belt of each of Examples 1 to 3, in which the rubber layer was obtained by mixing high molecular weight HNBR having a high Mooney viscosity (high molecular weight), is higher than that of the toothed belt of Comparative Example 1 in which the rubber layer was obtained by mixing no high molecular weight HNBR.

### (c) EVALUATION OF WEAR RESISTANCE OF RUBBER LAYER

For the toothed belt of each of Examples 1 to 3 and Comparative Example 1 described above, measurement was made on a thickness of the rubber layer of the belt main body (i.e., a distance between a belt main body rear surface and a cord central axis) upon lapse of 1000 hours using the same apparatus as the foregoing rubber layer bending fatigue resistance measurement apparatus under the same measurement conditions.

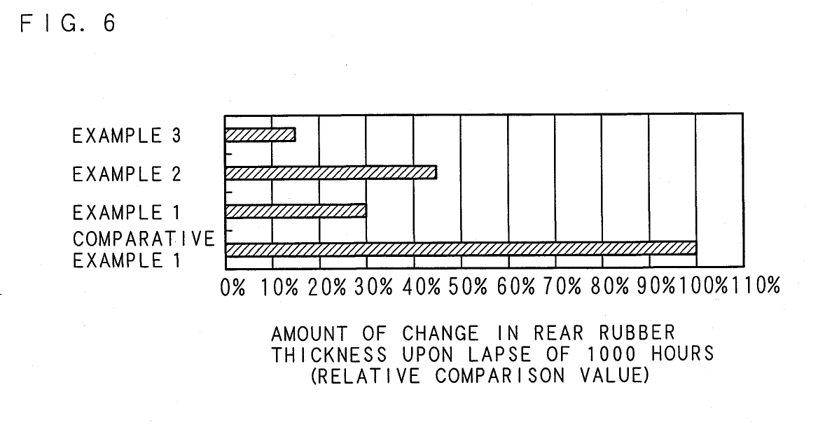

FIG. 6 is a graph illustrating an amount of change in rubber layer thickness of the belt main body upon lapse of 1000 hours for each toothed belt. The amount of change in Comparative Example 1 is determined as 100%.

It can be seen from FIG. 6 that the amount of change in the toothed belt of each of Examples 1 to 3, in which the rubber layer was obtained by mixing high molecular weight HNBR having a high Mooney viscosity (high molecular weight), is smaller than the amount of change in the toothed belt of Comparative Example 1 in which the rubber layer was obtained by mixing no high molecular weight HNBR, and the wear resistance of the toothed belt of each of Examples 1 to 3 is higher than that of the toothed belt of Comparative Example 1. Besides, the toothed belt of Example 3, in which hydrogenated carboxyl nitrile rubber was mixed, has the highest wear resistance.

From the above-described evaluation results (a) to (c), it was confirmed that the toothed belt has high strength and high rigidity and also has favorable bending fatigue resistance and wear resistance by mixing, as a rubber layer composition, high molecular weight HNBR in addition to the polymer alloy. It was also confirmed that the wear resistance is further improved by further mixing hydrogenated carboxyl NBR.

### (d) EVALUATION OF LOW TEMPERATURE RESISTANCE AND OIL RESISTANCE OF RUBBER LAYER

For the toothed belt of each of Examples 1 to 3 and Comparative Example 1 described above and for a chloroprene rubber belt, low temperature resistance and oil resistance were evaluated.

FIG. 7 is a schematic diagram illustrating an apparatus for evaluating low temperature resistance.

In an ultracold freezer 13, a toothed belt 15 was stretched between two pulleys 14, 14, and the pulleys 14 were rotated by a motor 16 to examine a relationship between the number of cycles and the number of cracks at a belt main body rear portion (rear rubber), which will be described below.

Measurement conditions are as follows.
Belt: Tooth Pitch of 8 mm, Length of 1000 mm, and Width of 20 mm
Pulley: 24 T×24 T
No Load
Rotation Speed: 750 r/min
One Cycle: Intermittent Operation with 1-Minute Operation and 10-Minute Suspension
Temperature in Ultracold Freezer: −35° C.

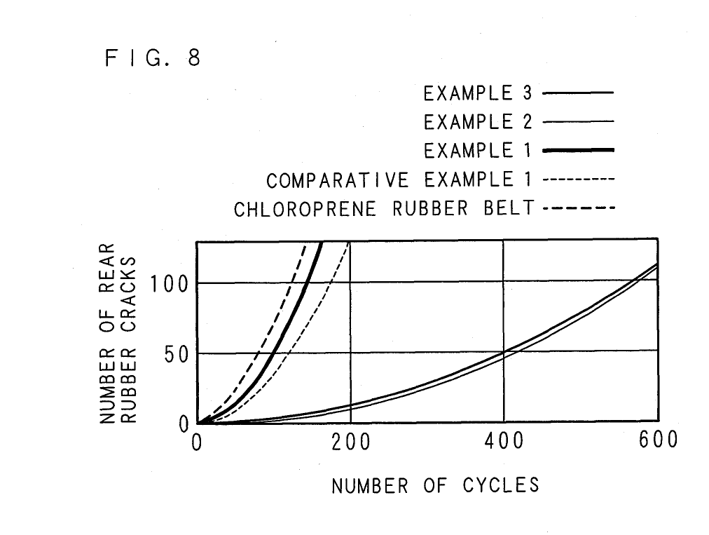

FIG. 8 is a graph illustrating results of the examination conducted on the relationship between the number of cycles and the number of rear rubber cracks for each toothed belt. It can be seen from FIG. 8 that the low temperature resistance of the toothed belt of each of Examples 2 and 3, in which the rubber layer contains the polymer alloy (2) whose base polymer is low-binding acrylonitrile content HNBR, is considerably improved as compared with the low temperature resistance of the other toothed belts.

Next, oil resistance was evaluated.

The rubber layer composition of Blending examples 1 to 4 described above and that of chloroprene rubber were each cross-linked (vulcanized) at 160° C. for 25 minutes, thus fabricating a rubber layer material (sheet).

Then, JIS NO. 3 oil was poured into an oil bath and kept at 60° C., and a given size cutout of each sheet was immersed in the oil to examine a relationship between immersion time and volume change rate.

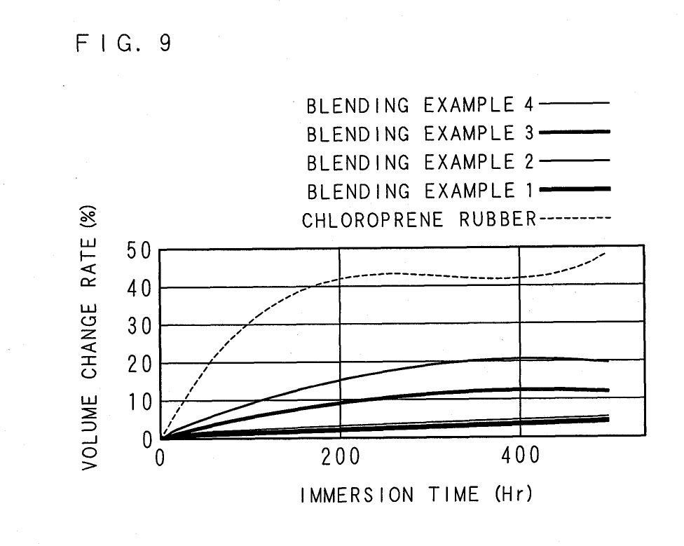

FIG. 9 is a graph illustrating results of the examination conducted on the relationship between immersion time and volume change rate. It can be seen that the oil resistance of the rubber layer material of each of Blending examples 2 and 3, serving as a component of the toothed belt and having favorable low temperature resistance, is slightly lower than that of the rubber layer material of each of Blending examples 1 and 4, but the oil resistance of the rubber layer material of each of Blending examples 2 and 3 is significantly improved as compared with that of the rubber layer material made of chloroprene.

From the above results, it can be seen that the low temperature resistance of the toothed belt is improved by mixing, in the rubber layer, the polymer alloy (2) whose base polymer is low-binding acrylonitrile content HNBR, and the toothed belt is allowed to have the low temperature resistance and oil resistance in a balanced manner by setting a mass ratio between high-binding or medium-binding acrylonitrile content HNBR and low-binding acrylonitrile content HNBR in a range of 15:85 to 80:20.

### (e) EVALUATION OF ADHESION BETWEEN RUBBER LAYER MATERIAL AND TOOTH CLOTH

The rubber layer compositions of Blending examples 1 to 4 described above were each combined with the tooth cloth 2 and cross-linked (vulcanized) at 160° for 25 minutes, thus fabricating a rubber/cloth vulcanized sheet.

First, the adhesion between each rubber layer material and the foregoing tooth cloth 2 was evaluated.

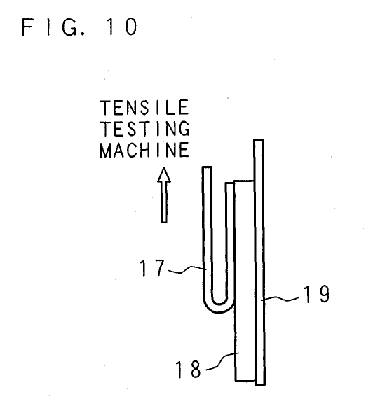

FIG. 10 is a diagram for describing a method for evaluating the adhesion between each rubber layer material and the tooth cloth.

The rubber/cloth vulcanized sheet was fixed to a back plate 19, and a portion of a tooth cloth 17 (i.e., the foregoing tooth cloth 2), which was not adhered to a rubber layer 18, was pulled by a tensile testing machine, thus determining adhesion strength.

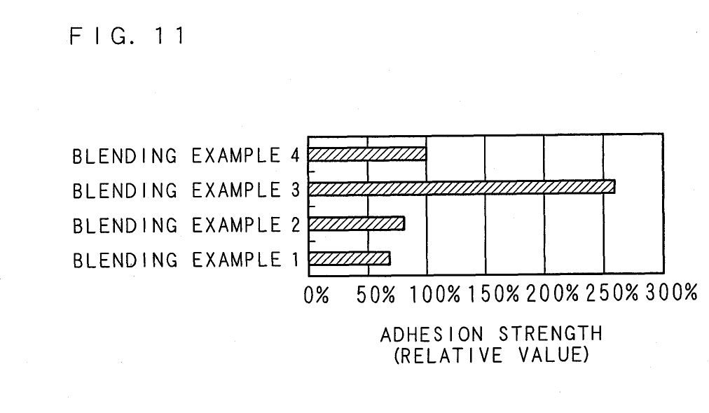

FIG. 11 is a graph illustrating the adhesion strength of the rubber layer material of each blending example when the adhesion strength of the rubber layer material of Blending example 4 is determined as 100%. It can be seen that the adhesion of the rubber layer material of Blending example 3, containing hydrogenated carboxyl NBR, to the tooth cloth 2 is considerably improved.

The rubber layer compositions of Blending examples 1 to 4 described above are each combined with the cords 1 to 3 and cross-linked (vulcanized) at 160° C. for 25 minutes, thus fabricating a rubber/cord vulcanized sheet.

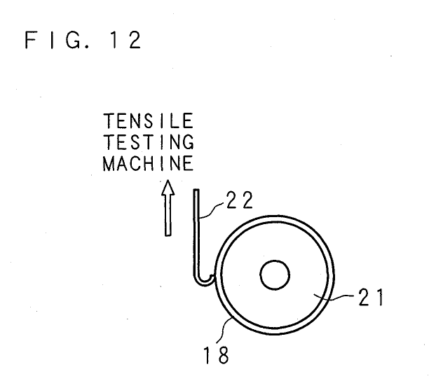

FIG. 12 is a diagram for describing a method for evaluating the adhesion between each rubber layer material and cord.

The rubber/cord vulcanized sheet was wrapped around a roller 21, and a cord 22 was pulled perpendicularly with respect to the rubber layer 18 and roller 21 by a tensile testing machine, thus determining adhesion strength.

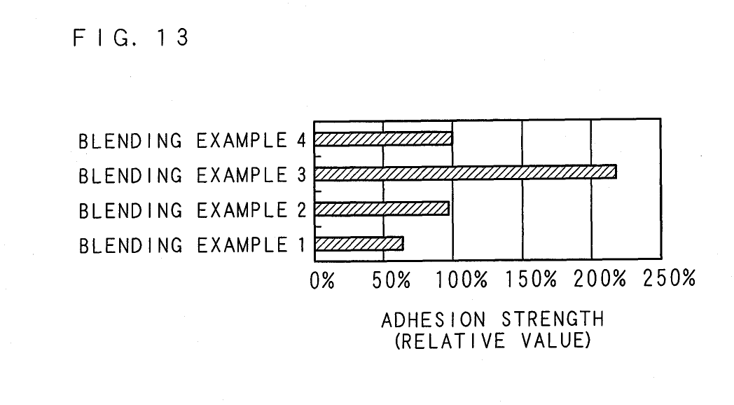

FIG. 13 is a graph illustrating evaluation results on the adhesion strength of the respective rubber layer materials, each obtained with the use of the cord 1. The adhesion strength of the rubber layer material of Blending example 4 is determined as 100%.

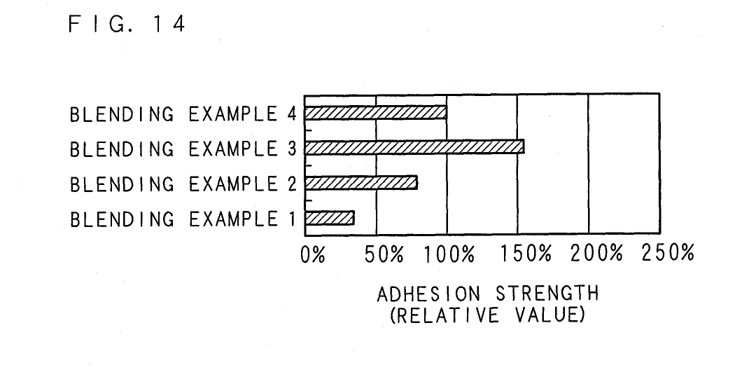

FIG. 14 is a graph illustrating evaluation results on the adhesion strength of the respective rubber layer materials, each obtained with the use of the cord 2. The adhesion strength of the rubber layer material of Blending example 4 is determined as 100%.

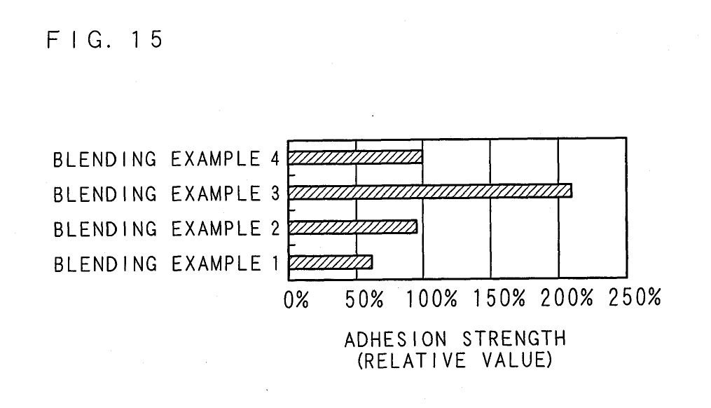

FIG. 15 is a graph illustrating evaluation results on the adhesion strength of the respective rubber layer materials, each obtained with the use of the cord 3. The adhesion strength of the rubber layer material of Blending example 4 is determined as 100%.

It can be seen from FIGS. 13 to 15 that the adhesion of the rubber layer material of Blending example 3, containing hydrogenated carboxyl NBR, to each cord is considerably improved. It can also be seen that the adhesion strength of the rubber layer material of Blending example 3 to the cord 1 is the highest, following by the adhesion strength of the rubber layer material of Blending example 3 to the cord 3, and the adhesion strength of the rubber layer material of Blending example 3 to the cord 2.

### (f) EVALUATION OF CONDUCTIVITY OF BELT SURFACE (TOOTH CLOTH SURFACE)

For the toothed belt of each of Examples 4 to 9 described above, conductivity was evaluated.

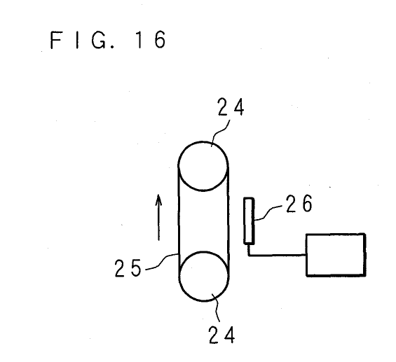

FIG. 16 is a schematic diagram illustrating an apparatus for evaluating conductivity.

A toothed belt 25 was stretched between two pulleys 24, 24, and static electricity generated at the toothed belt 25 was measured by a static electricity sensor 26.

Measurement conditions are as follows.
Belt: Tooth Pitch of 8 mm, Length of 1000 mm, and Width of 25 mm
Pulley (made of iron): 30 T×30 T
Rotation Speed: 1000 r/min
No Load

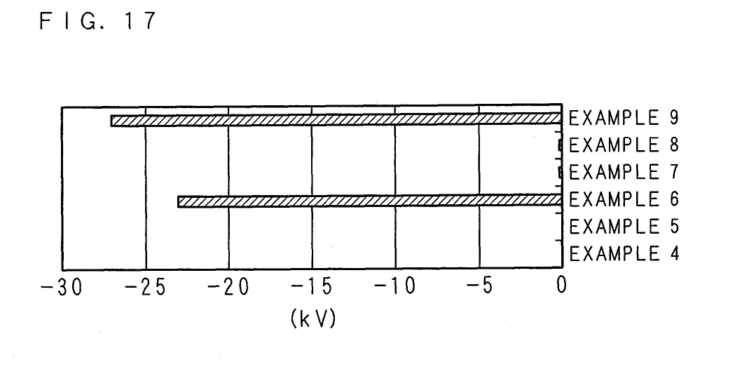

FIG. 17 is a graph illustrating generated static electricity amounts. A conductive material was exposed at the surface of the cloth base material 61. Electric potentials (kV) of surfaces of the toothed belts of Examples 4, 5, 6, 7, 8 and 9 are 0, 0, −23, −0.1, −0.1 and −27, respectively.

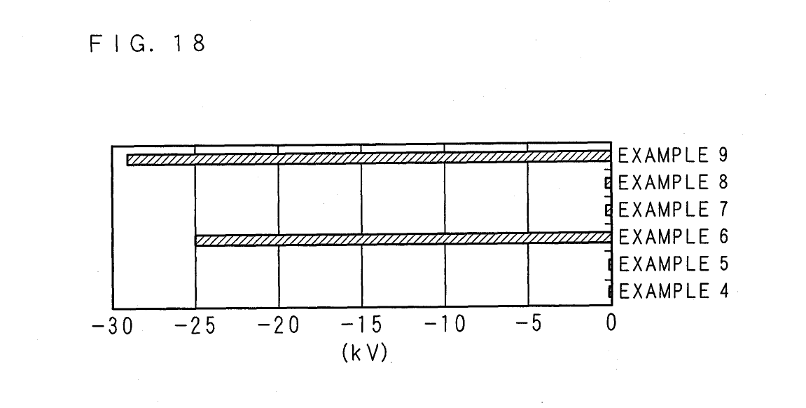

FIG. 18 is a graph illustrating generated static electricity amounts. A conductive material was not exposed at the surface of the cloth base material 61. Electric potentials (kV) of surfaces of the toothed belts of Examples 4, 5, 6, 7, 8 and 9 are −0.1, −0.1, −25, −0.3, −0.3 and −29, respectively.

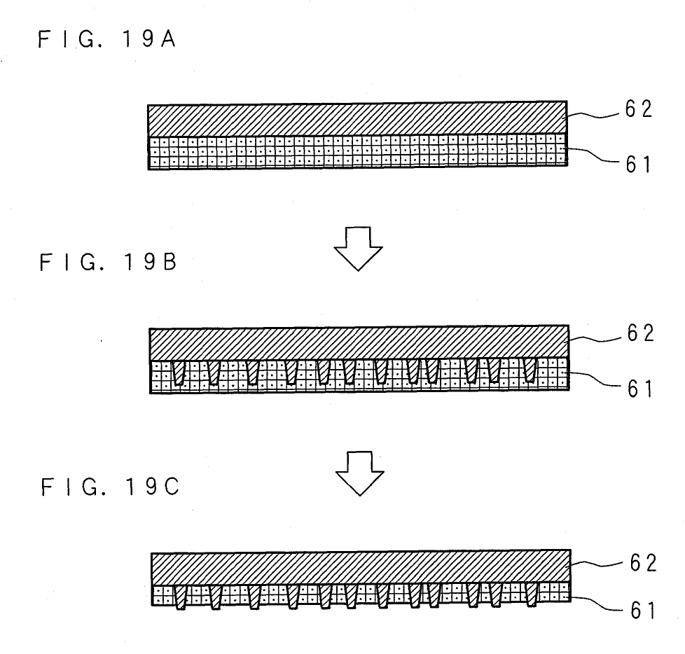

FIGS. 19A to 19C are diagrams for describing a method for controlling exposure of an adhesion layer.

FIG. 19A corresponds to the state of FIG. 3C described above.

By adjusting pressure and temperature when the teeth portions 5 are molded from this state, the adhesion layer 62 is prevented from being exposed at the surface of the cloth base material 61 or no conductive material (no conductive carbon) is exposed, and the adhesion layer 62 or the conductive material is allowed to exist inside the cloth base material 61 (FIG. 19B). Alternatively, the adhesion layer 62 may be exposed at the surface of the cloth base material 61 by adjusting pressure and temperature.

Even when the adhesion layer 62 is not exposed at the surface as illustrated in FIG. 19B, a minute amount of the adhesion layer 62 is temporarily exposed through the grain due to factors such as the fit between the tooth cloth and pulley during initial operation, and initial belt tension or load tension during operation, and the conductive material is thus exposed, so that charged electricity is grounded to the pulley through the adhesion layer 62 (FIG. 19C).

It can be seen from FIGS. 17 and 18 that the toothed belt of each of Examples 4 and 5, in which the adhesion layer 62 contains conductive carbon and the surface layer contains conductive zinc oxide, has most favorable conductivity. Further, it can also be seen from Examples 7 and 8 that favorable conductivity is provided even when the adhesion layer contains conductive carbon and the surface layer contains no conductive zinc oxide.

Furthermore, from the comparison made between FIGS. 17 and 18, it can be seen that the conductivity is higher when the conductive material is exposed at the surface of the toothed belt, but even when no conductive material is exposed at the surface of the toothed belt, the conductive material is temporarily exposed as illustrated in FIG. 19C, thus obtaining favorable conductivity.

### (g) EVALUATION OF ADHESION OF TOOTH CLOTH

The rubber layer composition of Blending example 3 described above was combined with each of the tooth cloths 1 to 6 and cross-linked (vulcanized) at 160° for 25 minutes, thus fabricating a rubber/cloth vulcanized sheet.

Similarly to FIG. 10, the rubber/cloth vulcanized sheet was fixed to the back plate 19, and a portion of the tooth cloth 17 (i.e., the foregoing tooth cloths 1 to 6), which was not adhered to the rubber layer 18 (i.e., the rubber layer of Blending example 3), was pulled by a tensile testing machine, thus determining adhesion strength.

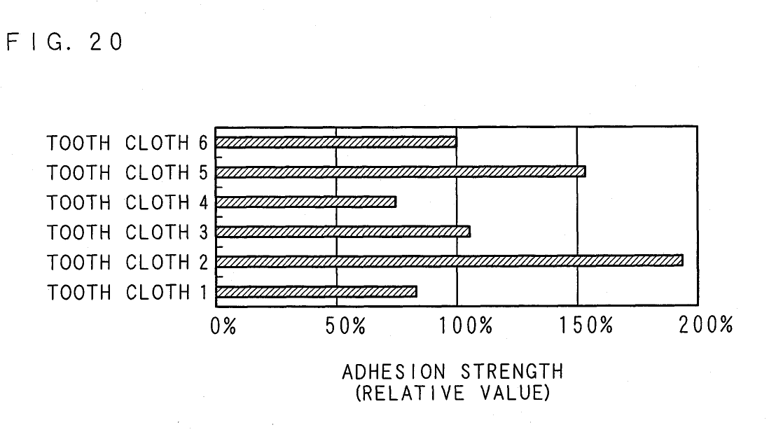

FIG. 20 is a graph illustrating adhesion strength of each tooth cloth when the adhesion strength of the tooth cloth 6 is determined as 100%. It can be seen from FIG. 20 that the tooth cloth 2, whose surface layer and adhesion layer both contain hydrogenated carboxyl NBR, has most favorable adhesion. The ranking of the blending examples of the adhesion layers for adhesion strength is as follows in descending order: Blending example B, Blending example C, and Blending example A. It can also be seen that the tooth cloth 5, whose adhesion layer contains hydrogenated carboxyl NBR and whose surface layer contains no hydrogenated carboxyl NBR, also achieves very high adhesion strength.

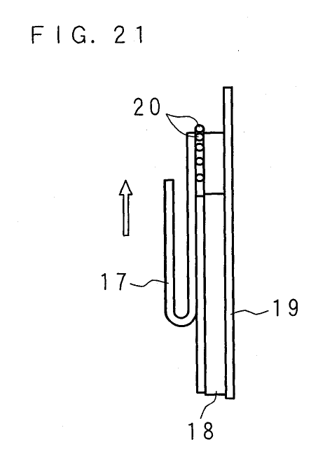

FIG. 21 is a diagram for describing a method for evaluating adhesion between each tooth cloth and cord.

The rubber layer composition of Blending example 3 was combined with each of the cords 1 to 3 and the tooth cloths 1 to 6 and cross-linked (vulcanized) at 160° for 25 minutes, thus fabricating a rubber/cord/cloth vulcanized sheet.

The rubber/cord/cloth vulcanized sheet was fixed to a back plate 19, and a portion of a tooth cloth 17, which was not adhered to cords 20 (i.e., the foregoing cords 1 to 3), was pulled by a tensile testing machine, thus determining adhesion strength. At a surface of a rubber layer 18, the cords 20 are densely arranged side by side.

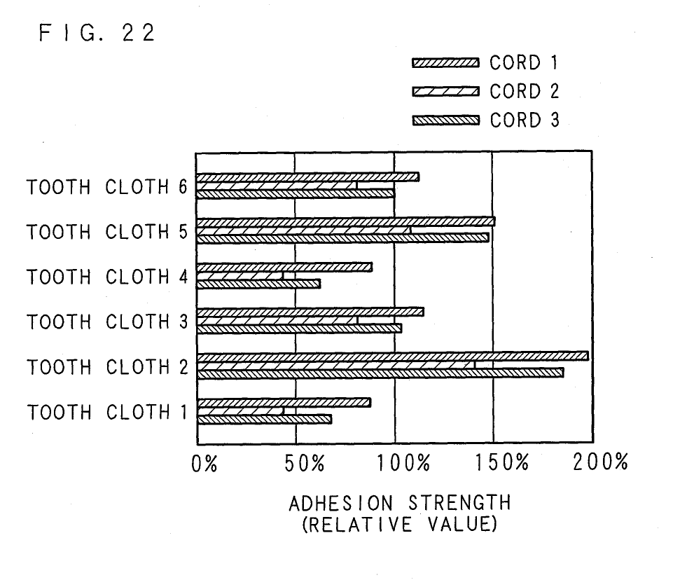

FIG. 22 is a graph illustrating adhesion strength of each tooth cloth to the cords 1 to 3 when the adhesion strength between the tooth cloth 6 and the cord 3 is determined as 100%. It can be seen from FIG. 22 that the tooth cloth 2, whose surface layer and adhesion layer both contain hydrogenated carboxyl NBR, has most favorable adhesion. The ranking of the blending examples of the adhesion layers for adhesion strength is as follows in descending order: Blending example B, Blending example C, and Blending example A. It can also be seen that the tooth cloth 5, whose adhesion layer contains hydrogenated carboxyl NBR and whose surface layer contains no hydrogenated carboxyl NBR, also achieves sufficiently high adhesion strength. Furthermore, the ranking of the cords for adhesion strength is as follows in descending order: the cord 1, the cord 3, and the cord 2.

### (h) EVALUATION OF WEAR RESISTANCE OF TOOTH CLOTH

For each of the toothed belts of Examples 4 to 9 described above, measurement was made on an amount of change in distance, i.e., PLD (Pitch Line Differential), between the central axis of the cord in the rubber layer of the belt main body and the surface of the tooth cloth (i.e., the surface of a region where a belt main body plane at which no teeth portion is formed is covered by the tooth cloth) upon lapse of 1000 hours under the same conditions using the same apparatus as the rubber layer bending fatigue resistance measurement apparatus illustrated in FIG. 4.

Measurement conditions are as follows.
Belt: Tooth Pitch of 8 mm, Length of 1000 mm, and Width of 20 mm
Pulley: 20 T (Diameter of 51 mm)×4
Idler Diameter: Diameter of 40 mm
Rotation Speed: 5500 r/min
Load: 197 N

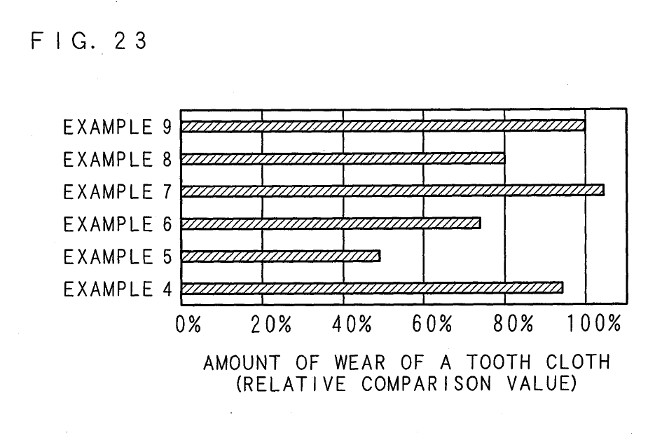

FIG. 23 is a graph illustrating an amount of wear of a tooth cloth upon lapse of 1000 hours in each toothed belt. The amount of wear in Example 9 is determined as 100%. It can be seen from FIG. 23 that the toothed belt of Example 5, including the tooth cloth 2 whose surface layer and adhesion layer both contain hydrogenated carboxyl NBR, has most favorable tooth cloth wear resistance. When the same blending example is used for the surface layers of the tooth cloths, the ranking of the blending examples of the adhesion layers for wear resistance is as follows in descending order: Blending example B, Blending example C, and Blending example A. On the other hand, when the same blending example is used for the adhesion layers of the tooth cloths, the ranking of the blending examples of the surface layers for wear resistance is as follows in descending order: Blending example I, and Blending example II.

### (i) EVALUATION OF SHOCK RESISTANCE OF TOOTHED BELT

For the toothed belt of each of Examples 1, 3, 9 to 11 and Comparative Example 1 described above, shock resistance was evaluated.

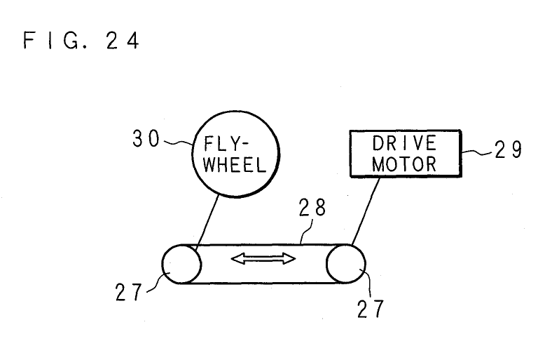

FIG. 24 is a schematic diagram illustrating an apparatus for evaluating shock resistance.

A toothed belt 28 was stretched between two pulleys 27, 27, a flywheel 30 was placed coaxially with one of the pulleys 27, the pulleys 27 were suddenly started and suddenly stopped by a drive motor 29 with forward and reverse rotations to apply shock to the toothed belt 28, and time elapsed before occurrence of belt failure was determined, thus evaluating shock resistance.

Measurement conditions are as follows.
Belt: Tooth Pitch of 8 mm, Length of 1000 mm, and Width of 15 mm
Pulley: 30 T×30 T
Peak Torque: 160N·m

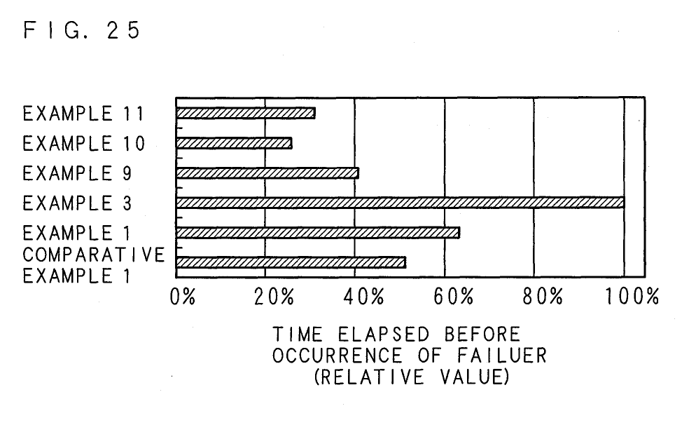

FIG. 25 is a graph illustrating time elapsed before occurrence of failure in each toothed belt. The elapsed time in Example 3 is determined as 100%.

From comparisons made on Examples 3, 10 and 11 with reference to FIG. 25, it can be seen that the ranking of the cords for shock resistance is as follows in descending order: the cord 1, the cord 3, and the cord 2. From comparisons made on Examples 1 and 3 and Comparative Example 1, it can be seen that the ranking of the blending examples of the rubber layer compositions for shock resistance is as follows in descending order: Blending example 3, Blending example 1, and Blending example 4. In other words, the wear resistance is improved when the rubber layer contains high molecular weight HNBR, and the wear resistance is further improved when the rubber layer contains hydrogenated carboxyl NBR. From a comparison made between Examples 3 and 9, it can be seen that the wear resistance provided when the surface layer and adhesion layer of the tooth cloth both contain hydrogenated carboxyl NBR is improved as compared with the wear resistance provided when the surface layer and adhesion layer of the tooth cloth contain no hydrogenated carboxyl NBR.

### (j) EVALUATION OF BENDING FATIGUE RESISTANCE OF TOOTHED BELT

For the toothed belt of each of Examples 1, 3, 9 to 11 and Comparative Example 1 described above, residual strength of the toothed belt upon lapse of 1000 hours was measured using an apparatus similar to that illustrated in FIG. 4.

Measurement conditions are as follows.
Belt: Tooth Pitch of 8 mm, Length of 1000 mm, and Width of 20 mm
Pulley: 20 T (Diameter of 51 mm)×4
Idler Diameter: Diameter of 40 mm
Rotation Speed: 5500 r/min
Load: 197 N

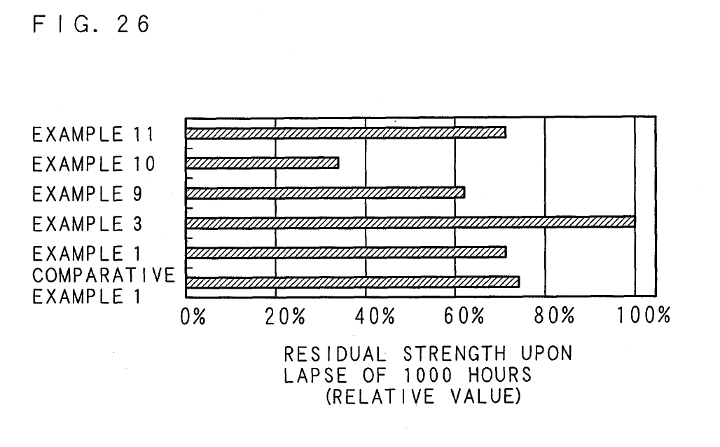

FIG. 26 is a graph illustrating residual strength upon lapse of 1000 hours in each toothed belt. The residual strength in Example 3 is determined as 100%.

From comparisons made on Examples 3, 10 and 11 with reference to FIG. 26, it can be seen that the ranking of the cords for residual strength is as follows in descending order: the cord 1, the cord 3, and the cord 2. From a comparison made between Example 3 and Comparative Example 1, it can be seen that the residual strength is improved when the rubber layer contains hydrogenated carboxyl NBR. From a comparison made between Examples 3 and 9, it can be seen that the residual strength provided when the surface layer and adhesion layer of the tooth cloth both contain hydrogenated carboxyl NBR is improved as compared with the residual strength provided when the surface layer and adhesion layer of the tooth cloth contain no hydrogenated carboxyl NBR.

### (k) EVALUATION OF LOAD DURABILITY OF TOOTHED BELT

For the toothed belt of each of Examples 1, 3, 9 to 11 and Comparative Example 1 described above, load durability was evaluated.

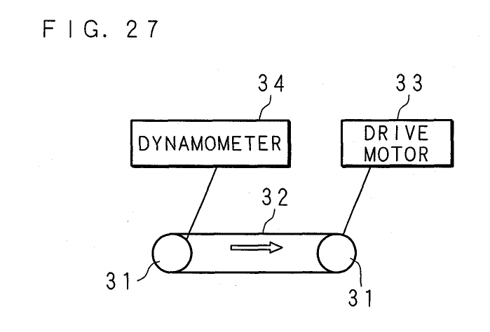

FIG. 27 is a schematic diagram illustrating an apparatus for evaluating load durability.

A toothed belt 32 was stretched between two pulleys 31, 31, and the pulleys 31 were rotated by a drive motor 33 in such a manner that continuous operation was carried out while load torque was checked by a dynamometer 34, thus determining time elapsed before occurrence of failure.

Measurement conditions are as follows.
Belt: Tooth Pitch of 8 mm, Length of 1000 mm, and Width of 15 mm
Pulley: 30 T×30 T
Load Torque: 68 N·m
Rotation Speed: 3000 r/min

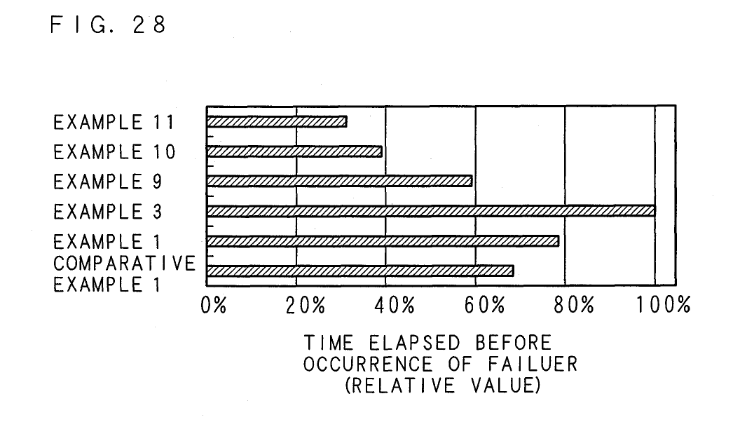

FIG. 28 is a graph illustrating time elapsed before occurrence of failure in each toothed belt. The elapsed time in Example 3 is determined as 100%.

From comparisons made on Examples 3, 10 and 11 with reference to FIG. 28, it can be seen that the ranking of the cords for load durability is as follows in descending order: the cord 1, the cord 2, and the cord 3. From comparisons made on Examples 1 and 3 and Comparative Example 1, it can be seen that the ranking of the blending examples of the rubber layer compositions for load durability is as follows in descending order: Blending example 3, Blending example 1, and Blending example 4. In other words, the load durability is improved when the rubber layer contains high molecular weight HNBR, and the load durability is further improved when the rubber layer contains hydrogenated carboxyl NBR. From a comparison made between Examples 3 and 9, it can be seen that the load durability provided when the surface layer and adhesion layer of the tooth cloth both contain hydrogenated carboxyl NBR is improved as compared with the load durability provided when the surface layer and adhesion layer of the tooth cloth contain no hydrogenated carboxyl NBR.

In the toothed belt of each of Example 1 and Comparative Example 1, tooth chipping occurs due to a tooth root crack caused by insufficient adhesion between the rubber layer and cords. In the toothed belt of Example 9, tooth chipping occurs due to floating of the tooth cloth, caused by insufficient adhesion between the tooth cloth and cords. In the toothed belt of Example 10, cutting occurs due to reduction in bending fatigue resistance of the cords. In the toothed belt of Example 11, tooth chipping occurs due to defective mesh caused by insufficient rigidity for load. But in the toothed belt of Example 3, no tooth chipping occurs until the tooth cloth is worn, and the toothed belt of Example 3 thus has a long life.

### (l) EVALUATION OF BELT DAMPING CHARACTERISTIC

For each of Examples 3 and 11 and Comparative Example 1 described above, belt damping characteristics were evaluated.

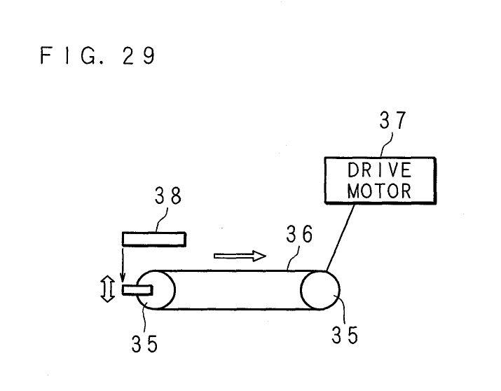

FIG. 29 is a schematic diagram illustrating an apparatus for evaluating belt damping characteristics.

A toothed belt 36 was stretched between two pulleys 35, 35, the driving pulley 35 was rotated one rotating by a drive motor 37, and oscillation of the driven pulley 35 was measured by a laser displacement meter 38 upon sudden stop of the driving pulley 35.

Measurement conditions are as follows.
Belt: Tooth Pitch of 8 mm, Length of 2800 mm, and Width of 20 mm
Pulley: 30 T×30 T
Acceleration Time: Rotation speed is increased from 0 to 200 r/min within 0.1 second.

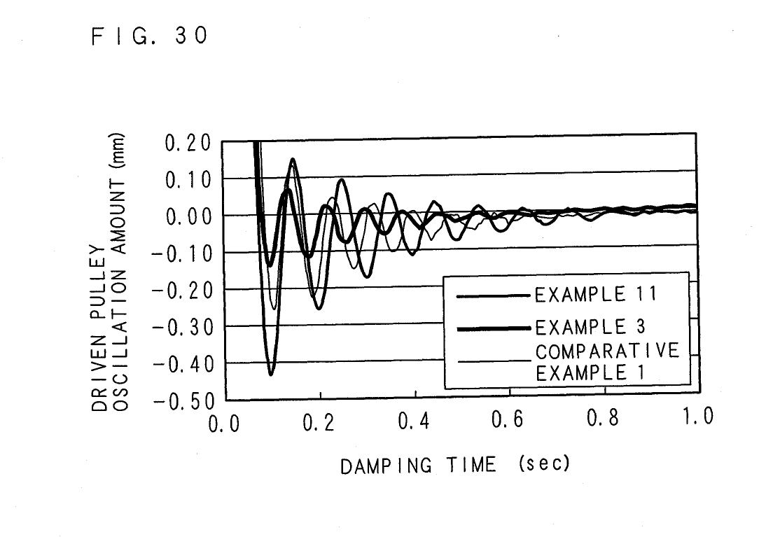

FIG. 30 is a graph illustrating relationships between damping time and driven pulley oscillation amount.

From a comparison made between Example 3 and Comparative Example 1 with reference to FIG. 30, it can be seen that favorable damping characteristic is obtained when the rubber layer contains high molecular weight HNBR and has high rigidity. Furthermore, from a comparison made between Examples 3 and 11, it can be seen that favorable damping characteristic is obtained by using the cord 1.

### (m) SUMMARY

Static properties and dynamic properties including bending fatigue resistance are improved and high strength and high rigidity are realized by mixing high molecular weight HNBR in the composition for the rubber layer of the belt main body in addition to the polymer alloy. In the obtained toothed belt, width reduction is realized due to high rigidity and high elasticity, thus implementing compact layout.

Moreover, combined with high hardness achieved by high molecular weight HNBR, high wear resistance is realized by mixing hydrogenated carboxyl NBR in the rubber layer composition. Hydrogenated carboxyl NBR has favorable affinity, and thus can improve wettability and adhesion of the rubber layer to other materials.

With improvements in the strength, rigidity, wear resistance and bending fatigue resistance of the rubber layer of the belt main body and the adhesion of the rubber layer to other materials, the power transmission performance, stopping accuracy and damping characteristic of the toothed belt are enhanced.

Further, the toothed belt can have low temperature resistance and oil resistance in a balanced manner by mixing, as the rubber layer composition, each of low-binding acrylonitrile content HNBR and high-binding or medium-binding acrylonitrile content HNBR within a given range.

The adhesion of the tooth cloth to the rubber layer and cords of the belt main body is improved by mixing hydrogenated carboxyl NBR in the rubber composition for the adhesion layer of the tooth cloth (and preferably also in the rubber composition for the surface layer). Furthermore, the improvement in the adhesion allows a large amount of PTFE to be added, and therefore, wear resistance is improved. When the rubber layer of the belt main body also contains hydrogenated carboxyl NBR, the toothed belt further has high durability.

The power transmission performance of the toothed belt is enhanced by improving the wear resistance of the tooth cloth and the adhesion thereof to the rubber layer and cords of the belt main body.

Conductive zinc oxide is mixed in the surface layer rubber composition, and conductive carbon is mixed in the adhesion layer rubber composition; thus, pressure and temperature are adjusted at the time of molding of the toothed belt, and the adhesion layer is exposed through the grain of the cloth base material, thereby exposing the conductive material. On the other hand, even when the adhesion layer is not exposed at the time of molding, a minute amount of the adhesion layer is temporarily exposed through the grain due to factors such as the fit between the tooth cloth and pulley during initial operation, and initial belt tension or load tension during operation, and the conductive material is thus exposed, so that charged electricity is grounded to the pulley through the adhesion layer. As a result, charging at the surface of the toothed belt is prevented.

With the use of the cords, in which carbon fibers and glass fibers are combined, in addition to the above-described features of the rubber layer and tooth cloth, the adhesion is further improved, and the toothed belt has more favorable rigidity, shock resistance and bending fatigue resistance.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. A toothed belt comprising:
a belt main body having a rubber layer which contains hydrogenated nitrile rubber, and a polymer alloy obtained by finely dispersing zinc methacrylate in a same type or different type of the hydrogenated nitrile rubber;
a plurality of teeth portions formed at least at one surface of the rubber layer; and
a tooth cloth in which an adhesion layer is formed at one surface of a cloth base material obtained by impregnating a surface layer rubber composition which contains hydrogenated nitrile rubber into a canvas, the tooth cloth being adhered to the belt main body so as to cover the teeth portions,
wherein the rubber layer contains the hydrogenated nitrile rubber in which a Mooney viscosity at 100° C. is in a range of from 100 to 160.

2. The toothed belt according to claim 1, wherein the rubber layer has a rubber hardness Hs of 95 or more, a 100% modulus of 18 MPa or more in a vulcanized rubber test, and a rubber rupture strength of 36 MPa or more.

3. The toothed belt according to claim 1, wherein the rubber layer contains the hydrogenated nitrile rubber, in which a Mooney viscosity at 100° C. is in a range of from 100 to 160, in a range of from 5 to 20 mass percentage with respect to the total amount of the rubber layer.

4. The toothed belt according to claim 1, wherein the rubber layer further contains hydrogenated carboxyl nitrile rubber.

5. The toothed belt according to claim 2, wherein the rubber layer further contains hydrogenated carboxyl nitrile rubber.

6. The toothed belt according to claim 4, wherein the rubber layer contains the hydrogenated carboxyl nitrile rubber in a range of from 1 to 30 mass percentage with respect to the total amount the rubber layer.

7. The toothed belt according to claim 1, wherein the rubber layer contains low-binding acrylonitrile content hydrogenated nitrile rubber in which the content of binding acrylonitrile is in a range of from 15 to 25 mass percentage.

8. The toothed belt according to claim 2, wherein the rubber layer contains low-binding acrylonitrile content hydrogenated nitrile rubber in which the content of binding acrylonitrile is in a range of from 15 to 25 mass percentage.

9. The toothed belt according to claim 7, wherein the rubber layer contains the low-binding acrylonitrile content hydrogenated nitrile rubber in a range of from 10 to 70 mass percentage with respect to the total amount of rubber components of the rubber layer.

10. The toothed belt according to claim 7, wherein the rubber layer contains hydrogenated nitrile rubber in which the content of binding acrylonitrile is in a range of from 35 to 50 mass percentage and a mass ratio of this hydrogenated nitrile rubber and the low-binding acrylonitrile content hydrogenated nitrile rubber is in a range of from 15:85 to 80:20.

11. The toothed belt according to claim 1, wherein the surface layer rubber composition of the tooth cloth contains hydrogenated carboxyl nitrile rubber.

12. The toothed belt according to claim 2, wherein the surface layer rubber composition of the tooth cloth contains hydrogenated carboxyl nitrile rubber.

13. The toothed belt according to claim 1, wherein the adhesion layer of the tooth cloth contains hydrogenated carboxyl nitrile rubber.

14. The toothed belt according to claim 2, wherein the adhesion layer of the tooth cloth contains hydrogenated carboxyl nitrile rubber.

15. The toothed belt according to claim 1, wherein the surface layer rubber composition contains polytetrafluoroethylene.

16. The toothed belt according to claim 1, wherein the surface layer rubber composition contains conductive zinc oxide.

17. The toothed belt according to claim 2, wherein the surface layer rubber composition contains conductive zinc oxide.

18. The toothed belt according to claim 1, wherein the adhesion layer contains conductive carbon.

19. The toothed belt according to claim 2, wherein the adhesion layer contains conductive carbon.

20. The toothed belt according to claim 1, wherein the belt main body has a cord in which a plurality of strands made of primarily-twisted glass fibers are disposed around a fiber core made of carbon fibers, and the fiber core and strands are finally twisted.
